(19) United States
(12) Patent Application Publication
(10) Pub. No.: US 2025/0354033 A1
(43) Pub. Date: Nov. 20, 2025

(54) HIGHLY MODIFIED COLLOIDAL SILICA TUNGSTEN CMP COMPOSITION

(71) Applicant: ENTEGRIS, INC., Billerica, MA (US)

(72) Inventors: Brittany Johnson, Oak Park, IL (US); Jason Seabold, Oswego, IL (US); Na Zhang, Naperville, IL (US); Kevin P. Dockery, Aurora, IL (US); Galyna Arora, Naperville, IL (US); Brian Reiss, Woodridge, IL (US); Alexander W. Hains, Aurora, IL (US); Steven Grumbine, Aurora, IL (US)

(21) Appl. No.: 19/207,099

(22) Filed: May 13, 2025

Related U.S. Application Data
(60) Provisional application No. 63/647,368, filed on May 14, 2024.

(51) Int. Cl. C09G 1/02; B24B 37/04; C09K 3/14

(52) U.S. Cl. CPC C09G 1/02; B24B 37/044; C09K 3/1436

(57) ABSTRACT

A chemical mechanical polishing composition includes a liquid carrier; an iron-containing compound; a cationic polymer or a cationic surfactant; highly modified colloidal silica particles dispersed in the liquid carrier, the highly modified colloidal silica particles modified with an aminosilane compound such that the colloidal silica particles are positively charged in the polishing composition, wherein the highly modified colloidal silica particles have a modification level of the aminosilane compound of greater than about 20 percent; and a pH of less than about 4.5.

### BACKGROUND OF THE INVENTION

Chemical mechanical polishing (CMP) compositions and methods for polishing (or planarizing) the surface of a substrate are well known. Polishing compositions (also known as polishing slurries, CMP slurries, and CMP compositions) for polishing metal layers (such as tungsten) on a semiconductor substrate may include abrasive particles (e.g., including silica particles) dispersed in an aqueous carrier and various chemical additives such as an oxidizer (e.g., hydrogen peroxide), a rate accelerator (e.g., a catalyst), and a corrosion inhibitor.

As transistor sizes continue to shrink, the use of conventional metal interconnect technology has become increasingly challenging. In many CMP operations, particularly for advanced tungsten interconnect applications, achieving optimum planarization and/or planarization efficiency is of critical importance. For example, in tungsten CMP operations excessive oxide erosion, dishing, and/or patterned oxide loss may lead to difficulties in subsequent lithography steps as well as cause electrical contact problems that can degrade electrical performance. Despite many advances to commercial CMP slurries, there remains a need in the industry for CMP slurries (or compositions) such as tungsten CMP slurries that provide for improved planarity (particularly improved erosion) during a CMP operation.

### BRIEF SUMMARY OF THE INVENTION

A chemical mechanical polishing composition is disclosed. The composition includes a liquid carrier; an iron-containing compound; a cationic polymer or a cationic surfactant; highly modified colloidal silica particles dispersed in the liquid carrier, the highly modified colloidal silica particles modified with an aminosilane compound such that the colloidal silica particles are positively charged in the polishing composition, wherein the highly modified colloidal silica particles have a modification level of the aminosilane compound of greater than about 20 percent; and a pH of less than about 4.5.

### DETAILED DESCRIPTION OF THE INVENTION

Chemical mechanical polishing compositions and methods for using those compositions to polish a substrate are disclosed. In one example embodiment, a chemical mechanical polishing composition includes highly modified colloidal silica particles dispersed in a liquid carrier. The colloidal silica particles are modified with an aminosilane compound to a modification level of at least about 20 percent such that the colloidal silica particles are positively charged in the polishing composition. The polishing composition further includes an iron-containing compound and a cationic polymer or a cationic surfactant. The pH is less than about 4.5.

In another example embodiment a polishing composition includes first, and second colloidal silica particles dispersed in a liquid carrier. The first colloidal silica particles are highly modified and are modified with a first aminosilane compound to a modification level of at least about 20 percent such that the first colloidal silica particles are positively charged in the polishing composition. The second colloidal silica particles are modified with a second aminosilane compound to a modification level in a range from about 1 percent to about 19 percent such that the second colloidal silica particles are also positively charged in the polishing composition. The polishing composition further includes an iron-containing compound and a cationic polymer or a cationic surfactant. The pH is less than about 4.5.

The polishing composition contains colloidal silica particles (abrasive particles) suspended in a liquid carrier. As used herein the term colloidal silica particles refers to silica particles that are prepared via a wet process rather than a pyrogenic or flame hydrolysis process which produces structurally different particles. The colloidal silica may be precipitated or condensation-polymerized silica, which may be prepared using any method known to those of ordinary skill in the art, such as by the sol gel method or by silicate ion-exchange. Condensation-polymerized silica particles are often prepared by condensing Si(OH)₄ to form substantially spherical particles.

The disclosed embodiments include colloidal silica particles that are highly modified with an aminosilane compound. As used herein, the term “modified” means that the aminosilane compound is bonded to or chemically attached to the surface of the colloidal silica particle, for example, via a condensation reaction between the silane group(s) in the modifying aminosilane compound and surface silanol group(s) on the colloidal silica particle. By “highly modified” it is meant that the modification level of the aminosilane compound on the surface of the colloidal silica is at least 20 percent (i.e., at least 20 percent of the silanol groups on the colloidal silica particles are reacted with the aminosilane compound).

In example embodiments, the highly modified colloidal silica particles may have a modification level of at least about 20 percent (e.g., at least about 21 percent, at least about 22 percent, at least about 23 percent, or at least about 24 percent) to achieve the desired polishing results. Moreover, the highly modified colloidal silica particles may have a modification level of less than or equal to about 50 percent (e.g., less than or equal to about 48 percent, less than or equal to about 46 percent, less than or equal to about 45 percent, less than or equal to about 42 percent, or less than or equal to about 40 percent) to promote colloidal stability of the colloidal silica particles in the polishing composition. Accordingly, the colloidal silica particles may have a percent theoretical surface coverage that is in a range from about 20 percent to about 50 percent (e.g., from about 21 percent to about 50 percent, from about 21 percent to about 48 percent, from about 22 percent to about 46 percent, from about 23 percent to about 44 percent, or from about 24 percent to about 42 percent).

It will be appreciated that the condensation reaction between the silane group(s) in the modifying aminosilane compound and surface silanol group(s) on the colloidal silica particle may be a reversible equilibrium reaction, such that the actual modification level may not equal the theoretical modification level (a modification level calculated based on the amount of aminosilane added to the composition). Moreover, the actual modification level in the polishing composition may depend upon the procedures used to formulate the composition. It will be appreciated that some procedures may strip or otherwise remove the aminosilane compound from the surface of the colloidal silica, thereby reducing the modification level.

In the disclosed embodiments, the modification level of the colloidal silica is measured using the following procedure. The polishing composition is first passed through a mixed bed ion exchange column to remove unbound or loosely bound aminosilane from the colloidal silica particles. After ionic exchange, the total aminosilane concentration in the polishing composition (both bound and unbound) is determined by digesting the composition (including the modified colloidal silica particles) in concentrated potassium hydroxide and evaluating the digested composition using proton nuclear magnetic resonance (NMR). The amount of unbound (e.g., dissolved) aminosilane in the polishing composition is determined by first removing the modified colloidal silica particles from the composition by ultra-centrifugation (e.g., at 40,000 rpm for 1 h) and then testing the decanted liquid layer using liquid chromatography mass spectrometry (LCMS) (for aminosilane concentrations in a range from about 1 to about 100 ppm) and/or NMR (for aminosilane concentrations in a range from about 100 to about 5000 ppm). The amount of bound (modifying) aminosilane is calculated as the difference between the measured total aminosilane and the measured unbound aminosilane. The modification level may then be calculated based upon the concentration of colloidal silica particles in the polishing composition and the BET surface area thereof (measured as described in Colloids and Surfaces A: Physicochem. Eng. Aspects 322 (2008) 248-252). For the purposes of this calculation the average number of surface silanol groups on the colloidal silica is assumed to be 4.5 per nm².

In the disclosed embodiments, highly modified colloidal silica particles may be prepared, for example, by admixing a sufficient amount of the aminosilane compound with a predetermined volume (or mass) of colloidal silica dispersion. The admixture may be heated, for example, to a temperature of at least 50 degrees C. (e.g., at least 60 degrees C., at least 65 degrees C., or at least 70 degrees C.) to promote a condensation reaction between the silane group(s) in the modifying aminosilane compound and surface silanol group(s) on the colloidal silica particle. The admixture may be heated for substantially any suitable time duration, for example, at least one hour (e.g., at least two hours, at least five hours, or at least ten hours). After cooling to room temperature, the resulting dispersion (including the modified colloidal silica particles) may optionally be passed through an ion exchange column to remove any unreacted aminosilane compound (or other impurities).

In preferred embodiments, the polishing composition including the highly modified colloidal silica particles has less than about 50 ppm (e.g., less than about 40 ppm, less than about 30 ppm, less than about 20 ppm, or less than about 10 ppm) of the modifying aminosilane compound free in the liquid carrier per 1 weight percent of the highly modified colloidal silica particles. By free it is meant that modifying aminosilane compound is not bound to the particle (e.g., dissolved in the liquid carrier or agglomerated and suspended in the liquid carrier). Thus, for example, a polishing composition including 0.3 weight percent of the highly modified colloidal silica particles preferably has less than about 15 ppm (e.g., less than about 12 ppm, less than about 9 ppm, less than about 6 ppm, or less than about 3 ppm) of the modifying aminosilane compound free in the liquid carrier. Likewise, a polishing composition including 3 weight percent of the highly modified colloidal silica particles (e.g., a concentrate) preferably has less than about 150 ppm (e.g., less than about 120 ppm, less than about 90 ppm, less than about 60 ppm, or less than about 30 ppm) of the modifying aminosilane compound free in the liquid carrier.

It has been found that the disclosed polishing compositions including highly modified colloidal silica particles and a cationic polymer or a cationic surfactant advantageously achieve improved patterned wafer performance and particularly improved erosion performance as compared to polishing compositions not including highly modified colloidal silica particles. In such embodiments, the polishing composition may preferably include a first highly modified colloidal silica, a second modified (not highly modified) colloidal silica and a cationic polymer.

The highly modified colloidal silica particles may include substantially any suitable colloidal silica particles. In other words, substantially any suitable colloidal silica particles may be highly modified and used in the disclosed polishing compositions. For example, the highly modified colloidal silica particles may have substantially any suitable average particle size as measured using a CPS Disc Centrifuge Particle size analyzer (e.g., Model DC24000 HR available from CPS Instruments, Prairieville, Louisiana). Note that as used herein the average particle size is taken to be the D50 of the measured distribution. In example embodiments, the highly modified colloidal silica particles may have an average particle size in a range from about 5 nm to about 300 nm (e.g., from about 10 nm to about 200 nm, from about 20 nm to about 200 nm, or from about 30 nm to about 150 nm). However, it has been found that in certain preferred embodiments, the highly modified colloidal silica particles may have an average particle size in a range from about 30 nm to about 100 nm (e.g., from about 30 nm to about 60 nm).

The highly modified colloidal silica particles may have substantially any suitable surface area. For example, the highly modified colloidal silica particles may further be characterized as having a BET surface area in a range from about 20 m²/g to about 200 m²/g (e.g., in a range from about 30 m²/g to about 180 m²/g, from about 40 m²/g to about 160 m²/g, from about 50 m²/g to about 150 m²/g, or from about 60 m²/g to about 120 m²/g). The BET surface area may be measured, for example, as described in Colloids and Surfaces A: Physicochem. Eng. Aspects 322 (2008) 248-252.

The highly modified colloidal silica particles may have substantially any suitable aspect ratio, however, in certain advantageous embodiments it is been found that highly modified colloidal silica particles having a higher aspect ratio may achieve improved patterned wafer polishing performance. Accordingly, the highly modified colloidal silica particles may be further characterized as having a number average aspect ratio of greater than about 1.1 (e.g., greater than about 1.15, greater than about 1.2, greater than about 1.25, greater than about 1.3, greater than about 1.35, or greater than about 1.4).

The aspect ratio of a colloidal silica particle is defined herein as the maximum caliper diameter of the particle divided by the minimum caliper diameter of the particle (hence the aspect ratio is always greater than or equal to 1). The number average aspect ratio represents a statistical measure of the average (median) aspect ratio of the colloidal silica particles in the polishing composition (on a number rather than a weight basis). The number average aspect ratio may be referred to as AR50 since statistically half (50%) of the particles have an aspect ratio less than the median value and half (50%) of the particles have an aspect ratio greater than the median value.

The number average aspect ratio of the colloidal silica particles in a polishing composition may be determined by evaluating a large number of particles in high magnification transmission electron microscopy (TEM) images (e.g., at a magnification in a range from about 10,000 to about 30,000). To obtain a statistically significant median aspect ratio it is generally necessary to measure and compute the aspect ratio for a large number of colloidal silica particles (e.g., at least 500 or more particles or even 1000 or more particles) using a plurality of images (e.g., at least 10 or more images, 15 or more images, or even 20 or more images). The maximum caliper diameter and the minimum caliper diameter of each of the particles may be measured manually (particle by particle), for example, using the scale bar on the TEM image. However, a user-guided automated process is practically preferred based upon the requirement to evaluate a large number of particles. Such automated processes preferably make use of commercially available image analysis software.

The highly modified colloidal silica particles may have substantially any suitable degree of aggregation. In other words, the highly modified colloidal silica particles may be aggregated, partially aggregated, and/or non-aggregated. For example, in some embodiments, a portion of the particles may be aggregated and the remainder may be non-aggregated. Non-aggregated particles are individually discrete particles (commonly referred to in the art as primary particles or primaries) that are generally spherical or nearly spherical in shape. Aggregated particles are particles in which multiple primary particles are clustered or bonded together to form aggregates having generally irregular or non-spherical shapes (such as elongated or branched). Non-aggregated (primary) particles may also be referred to herein as monomers. Aggregated particles may also be referred to as dimers (having two primaries), trimers (having three primaries), tetramers (having four primaries), and so on.

In example embodiments, the highly modified colloidal silica particles may be substantially non-aggregated in that they include mostly primary particles. In other embodiments, the highly modified colloidal silica particles may be partially aggregated. By partially aggregated it may be meant that 50 percent or more of the highly modified colloidal silica particles include two or more aggregated primary particles or that 30 percent or more (or 45 percent or more) of the colloidal silica particles include three or more aggregated primary particles. In still other embodiments, the highly modified colloidal silica particles may have an aggregate distribution in which 20 percent or more of the highly modified colloidal silica particles include less than three primary particles (i.e., non-aggregated primary particles or aggregated particles having just two primary particles, also referred to as monomers and dimers) and 50 percent or more of the highly modified colloidal silica particles include three or more aggregated primary particles.

Partially aggregated colloidal silica abrasives may be prepared, for example, using a multi-step process in which primary particles are first grown in solution, for example as described in U.S. Pat. No. 5,230,833. The pH of the solution may then be adjusted to an acidic value for a predetermined time period to promote aggregation (or partial aggregation), for example, as described in U.S. Pat. No. 8,529,787. An optional final step may allow for further growth of the aggregates (and any remaining primary particles).

The highly modified colloidal silica particles have a positive charge in the polishing composition (e.g., in the liquid carrier). The charge on colloidal silica particles is commonly referred to in the art as the zeta potential (or the electrokinetic potential). As known to those of ordinary skill in the art, the zeta potential of a particle refers to the electrical potential difference between the electrical charge of the ions surrounding the particle and the electrical charge of the bulk solution of the polishing composition (e.g., the liquid carrier and any other components dissolved therein). The zeta potential may be obtained using commercially available instrumentation such as the Zetasizer available from Malvern Instruments, the ZetaPlus Zeta Potential Analyzer available from Brookhaven Instruments, and/or an electro-acoustic spectrometer available from Dispersion Technologies, Inc.

The highly modified colloidal silica particles preferably have a zeta potential in the polishing composition of about 20 mV or more (e.g., about 25 mV or more or about 30 mV or more). The highly modified colloidal silica particles may have a zeta potential in the polishing composition of about 60 mV or less (e.g., about 55 mV or less or about 50 mV or less). Accordingly, it will be understood that the highly modified colloidal silica particles may have a zeta potential in the polishing composition in a range bounded by any one of the aforementioned endpoints, for example, in a range from about 20 mV to about 60 mV (e.g., about 25 mV to about 60 mV, or about 30 mV to about 50 mV).

It will be appreciated that highly modifying colloidal silica particles with an aminosilane compound may increase the isoelectric point (IEP) of the particles (as compared to colloidal silica particles that are not highly modified or have a lower modification level). In example embodiments the modification level is sufficiently high such that the IEP of the highly modified colloidal silica particles is at least about 7 (e.g., at least about 7.5, or at least about 8).

For the purposes of this disclosure the IEP is measured on the as-modified colloidal silica particles before the addition of other polishing composition compounds (e.g., the iron-containing accelerator or the cationic polymer). The IEP is determined by titrating a sample using the electroacoustic method (e.g., via a Colloidal Dynamics Zetaprobe). The colloidal silica dispersion is diluted in deionized water to a solids (silica) concentration in a range from 2 to 5 weight percent. The diluted sample is titrated with 0.1N potassium hydroxide for a base titration (sample pH to 10.5). The zeta potential is measured at least every 0.5 pH units during the titration. The IEP is identified by determining the pH value at which the zeta potential is 0 mV. The precise IEP value may be computed via interpolation between the pH values at which the zeta potential transitions from positive to negative.

In example embodiments, the colloidal silica particles may include a mixture of at least first and second colloidal silica particles. The mixture may include, for example, a mixture of first highly modified colloidal silica particles and second modified (but not highly modified) colloidal silica particles. In such embodiments, the first colloidal silica particles may have a modification level of the first aminosilane particles that is greater than about 20 percent (and optionally less than about 50 percent, e.g., in a range from about 21 percent to about 50 percent, in a range from about 21 percent to about 48 percent, from about 22 percent to about 46 percent, from about 23 percent to about 44 percent, or from about 24 percent to about 42 percent) as described above and the second colloidal silica particles may have a modification level of the second colloidal silica particles that is less than about 20 percent, such as in a range from about 1 percent to about 19 percent (e.g., from about 2 percent to about 15 percent, from about 2 percent to about 12 percent, or from about 3 percent to about 12 percent).

Moreover, in embodiments including a mixture of a first highly modified colloidal silica and a second modified (but not highly modified) colloidal silica, the first colloidal silica particles and the second colloidal silica particles may be mixed at a weight ratio ranging from about 1:15 to about 15:1 (e.g., from about 1:15 to about 1:1, from about 1:1 to about 15:1, from about 1:10 to about 10:1, or from about 1:5 to about 5:1). In more particular embodiments, the first colloidal silica particles and the second colloidal silica particles may be mixed at a weight ratio ranging from about 2:1 to about 1:5 (e.g., from about 2:1 to about 1:2).

In example embodiments, the first highly modified colloidal silica particles may have an aspect ratio of greater than about 1.25 (e.g., greater than about 1.3 or greater than about 1.35) and the second modified (but not highly modified) colloidal silica particles may be characterized as having an aspect ratio of less than about 1.25 (e.g., less than about 1.2 or less than about 1.15). Moreover, in such embodiments, the first highly modified colloidal silica particles may have a particle size in a range from about 30 nm to about 80 nm (e.g., from about 30 to about 60) while the second modified colloidal silica particles may have a particles size that is greater than about 80 nm (e.g., greater than about 90 nm or greater than about 100 nm).

In embodiments including a blend of first and second colloidal silicas the blended colloidal silicas may include substantially any suitable commercially available colloidal silicas. Those of ordinary skill in the art will readily appreciate that colloidal silicas having a wide range of physical properties are commercially available from a large number of vendors, for example, including Nissan Chemical Industries, Ltd., Nalco Holding Company, W.R. Grace and Company, Fuso Chemical Company, Nouryon, Nyacol Nano Technologies, Inc., Tama Chemicals Company, and JGC Holdings Corporation.

The modifying aminosilane compound may include substantially any suitable aminosilane compound, for example, including primary aminosilanes, secondary aminosilanes, tertiary aminosilanes, quaternary aminosilanes, and multi-podal (e.g., dipodal) aminosilanes. The aminosilane compound may include substantially any suitable aminosilane, for example, a propyl group containing aminosilane, or an aminosilane compound including a propyl amine. Examples of suitable classes of aminosilanes may include bis(2-hydroxyalkyl)-3-aminoalkyl trialkoxysilane, dialkylaminoalkyltrialkoxysilane (e.g., dialkylaminoalkoxysilane), (N,N-dialkyl-3-aminoalkyl)trialkoxysilane), 3-(N-styrylalkyl-2-aminoalkylaminoalkyl trialkoxysilane, aminoalkyl trialkoxysilane, (2-N-benzylaminoalkyl)-3-aminoalkyl trialkoxysilane), trialkoxysilyl alkyl-N,N,N-trialkyl ammonium, N-(trialkoxysilylalkyl)benzyl-N,N,N-trialkyl ammonium, (bis(alkyldialkoxysilylalkyl)-N-alkhyl amine, bis(trialkoxysilylalkyl)urea, bis(3-(trialkoxysilyl)alkyl)-ethylenediamine, bis(trialkoxysilylalkyl)amine, bis(trialkoxysilylalkyl)amine, 3-aminoalkyltrialkoxysilane, N-(2-aminoalkyl)-3-aminopropylmethyldialkoxysilane, N-(2-aminoalkyl)-3-aminoalkyltrialkoxysilane, 3-aminoalkylmethyldialkoxysilane, 3-aminoalkyltrialkoxysilane, (N-trialkoxysilylalkyl)polyethyleneimine, trialkoxysilylalkyldiethylenetriamine, N-phenyl-3-aminoalkyltrialkoxysilane, N-(vinylbenzyl)-2-aminoalkyl-3-aminoalkyltrialkoxysilane, 4-aminoalkyltrialkoxysilane, and mixtures thereof.

In preferred embodiments, the highly modified colloidal silica particles may be modified with a multi-podal (e.g., dipodal) aminosilane, such as bis(trialkoxysilyl)ethane, bis(trialkoxysilylalkyl)amine (e.g., bis(trialkoxysilylalkyl)amine or bis(trialkoxysilylpropyl) N-(hydroxyalkyl)-N,N-bis(trialkoxysilylalkyl)amine, N,N′-bis[(3-amine), trialkoxysilyl)alkyl]ethylenediamine, N,N′-bis(2-hydroxyalkyl)-N,N′-bis(trialkoxysilylalkyl)ethylenediamine, tris(trialkoxysilylalkyl)amine, 1,11-bis(trialkoxysilyl)-4-oxa-8-azaundecan-6-ol, and mixtures thereof. Those of ordinary skill in the art will readily appreciate that aminosilane compounds are commonly hydrolyzed (or partially hydrolyzed) in an aqueous medium. Thus, by reciting an aminosilane compound, it will be understood that the modifying aminosilane may include a hydrolyzed (or partially hydrolyzed) species and/or condensed species thereof.

It will be appreciated that in embodiments including a mixture of first highly modified colloidal silica particles and second modified (but not highly modified) colloidal silica particles that the colloidal silica particles are generally modified prior to mixing. Moreover, it will be appreciated that in blended colloidal silica embodiments that the first colloidal silica particles and the second colloidal silica particles are not necessarily treated with the same aminosilane compound. As described above, in certain advantageous embodiments, the first colloidal silica particles may have a higher aminosilane modification level than the second colloidal silica particles.

The polishing composition may include substantially any suitable amount of the above described colloidal silica particles (including the highly modified colloidal silica particles). For example, the polishing composition may include about 0.01 wt. % or more colloidal silica particles at point of use (e.g., about 0.05 wt. % or more, about 0.1 wt. % or more, or about 0.2 wt. % or more). The amount of colloidal silica particles in the polishing composition may include about 5 wt. % or less at point of use (e.g., about 3 wt. % or less, about 2 wt. % or less, about 1.5 wt. % or less, or about 1 wt. % or less) Accordingly, it will be understood that the amount of colloidal silica particles may be in a range bounded by any two of the aforementioned endpoints, for example, in a range from about 0.01 wt. % to about 5 wt. % at point of use (e.g., from about 0.05 wt. % to about 5 wt. %, from about 0.1 wt. % to about 3 wt. %, from about 0.1 wt. % to about 2 wt. %, or from about 0.2 wt. % to about 1 wt. %).

In example embodiments including first highly modified colloidal silica particles and second modified colloidal silica particles, the polishing composition may advantageously include from about 0.01 wt. % to about 1 wt. % (e.g., from about 0.02 wt. % to about 0.5 wt. %) of the first highly modified colloidal silica particles at point of use. The polishing composition may further include from about 0.02 wt. % to about 2 wt. % (e.g., about 0.1 to about 1 wt. %) of the second modified colloidal silica particles at point of use.

The polishing composition is generally acidic having a pH of less than about 7. The polishing composition may have a pH of about 1 or more (e.g., about 2 or more). Moreover, the polishing composition may have a pH of about 6 or less (e.g., about 5 or less, about 4.5 or less, about 4 or less, about 3.5 or less, or about 3 or less). It will be understood that the polishing composition may have a pH in a range bounded by any two of the aforementioned endpoints, for example, in a range from about 1 to about 6 (e.g., from about 2 to about 5, from about 2 to about 4.5, or from about 2 to about 3).

The pH of the polishing composition may be achieved and/or maintained by any suitable means. The polishing composition may include substantially any suitable pH adjusting agents or buffering systems. For example, suitable pH adjusting agents may include nitric acid, sulfuric acid, phosphoric acid, phthalic acid, citric acid, adipic acid, oxalic acid, malonic acid, maleic acid, ammonium hydroxide, and the like while suitable buffering agents may include phosphates, sulfates, acetates, malonates, oxalates, borates, ammonium salts, and the like.

Disclosed polishing compositions may include substantially any suitable chemical additives. Polishing compositions configured for polishing tungsten and/or molybdenum may include, for example, one or more of the following components: an oxidizing agent, a polishing rate accelerating agent such as iron-containing compound, a topography control agent such as a cationic surfactant and/or a cationic polymer, an etch inhibitor, pH buffering agents, dispersants, and biocides. In certain example embodiments, the polishing composition may be configured for tungsten and/or molybdenum buff applications and may include an iron-containing compound and a cationic surfactant. In other example embodiments, the polishing composition may be configured for bulk tungsten and/or molybdenum applications and may include an iron-containing compound and a cationic polymer. Notwithstanding, such additives are purely optional. The disclosed embodiments are not so limited and do not require the use of any one or more of such additives.

In example embodiments, the disclosed polishing composition may be configured for polishing at least one metal layer. In such embodiments, the polishing composition may further include a metal polishing accelerator such as an oxidizer, a chelating or complexing agent, a catalyst, or any other suitable compound that increases the polishing rate of the metal layer. For example, an iron-containing compound may be used to increases the polishing rate of tungsten and/or molybdenum layers. The iron-containing compound may include a soluble iron-containing catalyst such as is disclosed in U.S. Pat. Nos. 5,958,288 and 5,980,775. Such an iron-containing catalyst may be soluble in the liquid carrier and may include, for example, ferric (iron III) or ferrous (iron II) compounds such as iron nitrate, iron sulfate, iron halides, including fluorides, chlorides, bromides, and iodides, as well as perchlorates, perbromates and periodates, and organic iron compounds such as iron acetates, carboxylic acids, acetylacetonates, citrates, gluconates, malonates, oxalates, phthalates, and succinates, and mixtures thereof.

An iron-containing accelerator may also include an iron-containing activator (e.g., a free radical producing compound) or an iron-containing catalyst associated with (e.g., coated or bonded to) the surface of the colloidal silica particle such as is disclosed in U.S. Pat. Nos. 7,029,508 and 7,077,880. For example, the iron-containing accelerator may be bonded with the silanol groups on the surface of the colloidal surface particles.

The amount of iron-containing accelerator in the polishing composition may be varied depending upon the oxidizing agent used and the chemical form of the accelerator. When the oxidizing agent is hydrogen peroxide (or one of its analogs) and a soluble iron-containing catalyst is used (such as ferric nitrate or hydrates of ferric nitrate), the catalyst may be present in the composition at point of use in an amount sufficient to provide a range from about 0.5 to about 3000 ppm Fe based on the total weight of the composition. For example, polishing compositions configured for bulk tungsten or molybdenum removal may include about 1 ppm Fe or more at point of use (e.g., about 5 ppm or more, about 10 ppm or more, or about 15 ppm or more). The polishing composition may include about 500 ppm Fe or less at point of use (e.g., about 200 ppm or less, about 100 ppm or less, or about 50 ppm or less). Accordingly, the point of use polishing composition may include Fe in a range bounded by any one of the above endpoints (e.g., from about 1 ppm to about 500 ppm, from about 5 ppm to about 200 ppm, from about 10 ppm to about 100 ppm, or from about 15 ppm to about 50 ppm). For tungsten or molybdenum buff applications that do not require high metal removal rates, the catalyst may be present in lower amounts, for example, from about 0.1 ppm to about 50 ppm Fe (e.g., from about 0.2 ppm to about 20 ppm or from about 0.2 to about 10 ppm) at point of use.

Embodiments of the polishing composition including an iron-containing accelerator may further include a stabilizer. Without such a stabilizer, the iron-containing accelerator and the oxidizing agent, if present, may react in a manner that degrades the oxidizing agent rapidly over time. The addition of a stabilizer tends to reduce the effectiveness of the iron-containing accelerator such that the choice of the type and amount of stabilizer added to the polishing composition may have a significant impact on CMP performance. The addition of a stabilizer may lead to the formation of a stabilizer/accelerator complex that inhibits the accelerator from reacting with the oxidizing agent, if present, while at the same time allowing the accelerator to remain sufficiently active so as to promote rapid tungsten or molybdenum polishing rates.

Useful stabilizers include phosphoric acid, organic acids such as polycarboxylic acids (e.g., dicarboxylic acids), phosphonate compounds, nitriles, and other ligands which bind to the metal and reduce its reactivity toward hydrogen peroxide decomposition and mixture thereof. The acid stabilizers may be used in their conjugate form, e.g., the carboxylate can be used instead of the carboxylic acid. The term “acid” as it is used herein to describe useful stabilizers also means the conjugate base of the acid stabilizer. Stabilizers can be used alone or in combination and significantly reduce the rate at which oxidizing agents such as hydrogen peroxide decompose.

Preferred stabilizers include phosphoric acid, acetic acid, phthalic acid, citric acid, adipic acid, oxalic acid, malonic acid, aspartic acid, succinic acid, glutaric acid, pimelic acid, suberic acid, azelaic acid, sebacic acid, maleic acid, glutaconic acid, muconic acid, ethylenediaminetetraacetic acid (EDTA), propylenediaminetetraacetic acid (PDTA), and mixtures thereof. The preferred stabilizers may be added to the compositions of this invention in an amount ranging from about 1 equivalent per iron-containing accelerator to about 3.0 weight percent or more (e.g., from about 1 equivalent to about 5 equivalents, or from about 3 equivalents to about 10 equivalents). As used herein, the term “equivalent per iron-containing accelerator” means one molecule of stabilizer per iron ion in the composition. For example, two equivalents per iron-containing accelerator means two molecules of stabilizer for each catalyst ion.

The polishing composition may optionally further include an oxidizing agent. The oxidizing agent may be added to the polishing composition during the slurry manufacturing process or just prior to the CMP operation (e.g., in a tank located at the semiconductor fabrication facility). Preferred oxidizing agents include inorganic or organic per-compounds. A per-compound as defined herein is a compound containing at least one peroxy group (—O—O—) or a compound containing an element in its highest oxidation state. Examples of compounds containing at least one peroxy group include but are not limited to hydrogen peroxide and its adducts such as urea hydrogen peroxide and percarbonates, organic peroxides such as benzoyl peroxide, peracetic acid, and di-t-butyl peroxide, monopersulfates (SO₅^{═}), dipersulfates (S₂O₈^{═}), and sodium peroxide. Examples of compounds containing an element in its highest oxidation state include but are not limited to periodic acid, periodate salts, perbromic acid, perbromate salts, perchloric acid, perchlorate salts, perboric acid, and perborate salts and permanganates. The most preferred oxidizing agent is hydrogen peroxide.

The oxidizing agent may be present in the polishing composition in substantially any suitable amount, for example, from about 0.0 wt. % to about 20 wt. % at point of use. In example embodiments configured for bulk tungsten or molybdenum removal that include a hydrogen peroxide oxidizer and a soluble iron-containing catalyst, the oxidizer may be present in the polishing composition in an amount ranging from about 0.1 wt. % to about 10 wt. % at point of use (e.g., from about 0.5 wt. % to about 5 wt. % or from about 1 wt. % to about 4 wt. %). In example embodiments configured for buff tungsten or molybdenum applications, the amount of hydrogen peroxide in the composition is generally less, for example, from about 0 wt. % to about 1 wt. %.

The polishing composition further includes at least one metal etch inhibitor and/or topography control agent. Suitable inhibitor compounds may inhibit the conversion of solid tungsten or molybdenum into soluble compounds while at the same time allowing for effective removal of the metal via the CMP operation. The polishing composition may include substantially any suitable inhibitor, for example, inhibitor compounds disclosed in commonly assigned U.S. Pat. Nos. 9,238,754; 9,303,188; and 9,303,189.

Example classes of compounds that that may be useful etch inhibitors include compounds having nitrogen containing functional groups such as nitrogen containing heteroycles, alkyl ammonium ions, amino alkyls, and amino acids. Useful amino alkyl corrosion inhibitors include, for example, hexylamine, tetraalkyl-p-phenylene diamine, octylamine, diethylene triamine, dialkyl benzylamine, aminoalkylsilanol, aminoalkylsiloxane, dodecylamine, mixtures thereof, and synthetic and naturally occurring amino acids including, for example, lysine, tyrosine, glutamine, glutamic acid, arginine, histidine, aspartic acid, cystine, and glycine (aminoacetic acid).

Suitable compounds may alternatively and/or additionally include an amine compound in solution in the liquid carrier. The amine compound (or compounds) may include a primary amine, a secondary amine, a tertiary amine, or a quaternary amine. The amine compound may further include a monoamine, a diamine, a triamine, a tetramine, or an amine based polymer having a large number of repeating amine groups (e.g., 4 or more amine groups).

Suitable compounds may alternatively and/or additionally be a cationic surfactant. The use of a cationic surfactant may advantageously reduce the metal etch rate and improve planarity (e.g., reducing dishing and/or erosion). In certain embodiments, the polishing compound may include a nitrogen containing cationic surfactant, such as a quaternary amine compound or a polyquaternary amine compound. By polyquaternary amine it is meant that the compound includes from 2 to 4 quaternary ammonium groups such that the polyquaternary amine is a diquaternary amine compound, a triquaternary amine compound, or a tetraquaternary amine compound. Diquaternary amine compounds may include, for example, N,N′-alkylenebis(dialkylteradecylammonium bromide), N,N,N′,N′,N′-pentaalkyl-N-tallow-1,3-propane-diammonium dichloride, N,N′-hexamethylenebis(trialkylammonium hydroxide), decamethonium bromide, didodecyl-tetraalkyl-1,4-butanediaminium diiodide, 1,5-dialkyl-1,5-diazoniabicyclo(3.2.2) nonane dibromide, dialkylcocoamine bis(chloroalkyl)ether diquaternary ammonium salt, and the like. Triquaternary amine compounds may include, for example, N(1),N(6)-didoecyl-N(1),N(1),N(6),N(6)-tetraalkyl-1,6-hexanediaminium diiodide. Tetraquaternary amine compounds may include, for example, methanetetrayltetrakis(tetraalkylammonium bromide). The polyquaternary amine compound may further include a long chain alkyl group (e.g., having 10 or more carbon atoms), For example, a polyquaternary amine compound having a long chain alkyl group may include N,N′-methylenebis(dialkyltetradecylammonium bromide), N,N,N′,N′,N′-pentaalkyl-N-tallow-1,3-propane-diammonium dichloride, didodecyl-tetraalkyl-1,4-butanediaminium di iodide, and N(1),N(6)-didodecyl-N(1),N(1),N(6),N(6)-tetraalkyl-1,6-hexanediaminium diiodide.

Suitable compounds may alternatively and/or additionally include a cationic polymer. Example cationic polymers include but are not limited to poly(vinylimidazolium), poly(methacryloyloxyalkyltrimethylammonium)chloride (polyMADQUAT), poly(diallyldimethylammonium)chloride (polyDADMAC) (e.g., Polyquaternium-6), poly(dialkylamine-co-epichlorohydrin), poly[bis(2-chloroethyl)ether-alt-1,3-bis[3-(dialkylamino)alkyl]urea] (e.g., Polyquaternium-2), copolymers of hydroxyalkyl cellulose and diallyldialkylammonium (e.g., Polyquaternium-4), copolymers of acrylamide and diallyldialkylammonium (e.g., Polyquaternium-7), quaternized hydroxyalkylcellulose ethoxylate (e.g., Polyquaternium-10), copolymers of vinylpyrrolidone and quaternized dialkylaminoalkyl methacrylate (e.g., Polyquatemium-11), copolymers of vinylpyrrolidone and quaternized vinylimidazole (e.g., Polyquatemium-16), Polyquaternium-24, a terpolymer of vinylcaprolactam, vinylpyrrolidone, and quaternized vinylimidazole (e.g., Polyquaternium-46), 3-Alkyl-1-vinylimidazolium alkyl sulfate-N-vinylpyrrolidone copolymer (e.g., Polyquaternium-44), and copolymers of vinylpyrrolidone and diallyldialkylammonium. Additionally, suitable cationic polymers include cationic polymers for personal care such as Luviquat® Supreme, Luviquat® Hold, Luviquat® UltraCare, Luviquat® FC 370, Luviquat® FC 550, Luviquat® FC 552, Luviquat® Excellence, GOHSEFIMER K210™, GOHSENX K-434, and combinations thereof.

Cationic polymers may also include an amino acid monomer (such compounds may also be referred to as polyamino acid compounds). Suitable polyamino acid compounds may include substantially any suitable amino acid monomer groups, for example, including polyarginine, polyhistidine, polyalanine, polyglycine, polytyrosine, polyproline, and polylysine. In example embodiments, polylysine may be a preferred polyamino acid. It will be understood that polylysine may include ε-polylysine and/or α-polylysine composed of D-lysine and/or L-lysine. The polylysine may thus include α-poly-L-lysine, α-poly-D-lysine, ε-poly-L-lysine, ε-poly-D-lysine, and mixtures thereof. The most preferred polylysine is ε-poly-L-lysine. It will further be understood that the polyamino acid compound (or compounds) may be used in any accessible form, e.g., the conjugate acid or base and salt forms of the polyamino acid may be used instead of (or in addition to) the polyamino acid.

In certain advantageous embodiments, the polishing composition may include first and second distinct inhibitor compounds. For example, the first inhibitor compound in the composition may include a cationic polymer such as a polyamino acid (with polylysine being preferred) and the second inhibitor compound in the composition may include an amino acid (with glycine, arginine, and a histidine being preferred).

The disclosed polishing compositions may include substantially any suitable concentration of the inhibitor compound and/or topography control agent. In general, the concentration is desirably high enough to provide adequate etch inhibition and topography control, but low enough so that the compound is soluble and so as not to reduce tungsten polishing rates below acceptable levels. By soluble it is meant that the compound is fully dissolved in the liquid carrier or that it forms micelles in the liquid carrier or is carried in micelles. It may be necessary to vary the concentration of the inhibitor compound depending upon numerous various factors, for example, including the solubility thereof, the number of amine groups therein, the length of an alkyl group, the relationship between etch rate inhibition and polishing rate inhibition, the oxidizing agent used, the concentration of the oxidizing agent, and so on. In example embodiments, the concentration of an amine compound in the polishing composition may be in a range from about 1 ppm by weight to about 200 ppm by weight at point of use (e.g., from about 5 ppm to about 100 ppm or from about 10 ppm to about 50 ppm). In example embodiments that include a cationic surfactant, the concentration of the cationic surfactant in the polishing composition may be in a range from about 0.1 ppm by weight to about 50 ppm by weight at point of use (e.g., from about 0.5 ppm to about 20 ppm or from about 1 ppm to about 10 ppm). In example embodiments that include a cationic polymer, the concentration of the cationic polymer in the polishing composition may be in a range from about 0.1 ppm by weight to about 100 ppm by weight at point of use (e.g., from about 1 ppm to about 50 ppm, from about 5 ppm to about 40 ppm, or from about 10 ppm to about 30 ppm).

The polishing composition may optionally further include a biocide. The biocide may include any suitable biocide, for example an isothiazolinone biocide. The amount of biocide in the polishing composition typically is in a range from about 1 ppm to about 50 ppm by weight at point of use or in a concentrate, and preferably from about 1 ppm to about 20 ppm.

The polishing composition may be prepared using any suitable techniques, many of which are known to those skilled in the art. The polishing composition may be prepared in a batch or continuous process. Generally, the polishing composition may be prepared by combining the components thereof in any order. The term “component” as used herein includes the individual ingredients (e.g., the colloidal silica, the iron-containing accelerator, the amine compound, etc.).

For example, the polishing composition components (such as an iron-containing accelerator, a stabilizer, an etch inhibitor, and/or a biocide) may be added directly to a colloidal silica having the above described physical properties (e.g., the specified aspect ratio, normalized span, and positive charge). In an alternative example, first and second colloidal silicas may optionally be treated, for example, with an aminosilane compound, so as to produce corresponding colloidal silicas having a positive charge. The first and second colloidal silicas may be mixed together prior to adding the other polishing composition components. Alternatively, the other components may be added to one of the colloidal silicas prior to mixing the first and second colloidal silicas together. The colloidal silica(s) and the other components may be blended together using any suitable techniques for achieving adequate mixing. Such blending/mixing techniques are well known to those of ordinary skill in the art. An optional oxidizing agent may be added at any time during the preparation of the polishing composition. For example, the polishing composition may be prepared prior to use, with one or more components, such as the oxidizing agent, being added just prior to the CMP operation (e.g., within about 1 minute, or within about 10 minutes, or within about 1 hour, or within about 1 day, or within about 1 week of the CMP operation). The polishing composition also may also be prepared by mixing the components at the surface of the substrate (e.g., on the polishing pad) during the CMP operation.

The polishing composition may advantageously be supplied as a one-package system comprising a colloidal silica having the above described physical properties and other optional components. An oxidizing agent may be desirably supplied separately from the other components of the polishing composition and may be combined, e.g., by the end-user, with the other components of the polishing composition shortly before use (e.g., 1 week or less prior to use, 1 day or less prior to use, 1 hour or less prior to use, 10 minutes or less prior to use, or 1 minute or less prior to use). Various other two-container, or three- or more-container, combinations of the components of the polishing composition are within the knowledge of one of ordinary skill in the art.

The polishing composition of the invention may also be provided as a concentrate which is intended to be diluted with an appropriate amount of water prior to use. In such an embodiment, the polishing composition concentrate may include the colloidal silica, water, and other optional components such as an iron-containing accelerator, a stabilizer, an etch inhibitor, and a biocide, with or without the oxidizing agent, in amounts such that, upon dilution of the concentrate with an appropriate amount of water, and an optional oxidizing agent if not already present in an appropriate amount, each component of the polishing composition will be present in the polishing composition in an amount within the appropriate ranges recited above for each component. For example, the colloidal silica and other optional components may each be present in the polishing composition in an amount that is about 2 times (e.g., about 3 times, about 4 times, about 5 times, or even about 10 times) greater than the point of use concentrations recited above for each component so that, when the concentrate is diluted with an equal volume of (e.g., 2 equal volumes of water, 3 equal volumes of water, 4 equal volumes of water, or even 9 equal volumes of water respectively), along with the oxidizing agent in a suitable amount, each component will be present in the polishing composition in an amount within the ranges set forth above for each component. Furthermore, as will be understood by those of ordinary skill in the art, the concentrate may contain an appropriate fraction of the water present in the final polishing composition in order to ensure that other components are at least partially or fully dissolved in the concentrate.

The disclosed polishing compositions may be used to polish substantially any substrate, for example, including a silicon nitride layer, a silicon oxide layer, and/or a metal layer such as a tungsten layer or a molybdenum layer. Certain advantageous embodiments may be particularly useful in the polishing of a substrate including at least one metal including tungsten and at least one dielectric material such as silicon oxide. Moreover, advantageous embodiments may provide stop-on-nitride (SoN) capability and may therefore exhibit very low removal rates of silicon nitride (such as PE-SiN). In such applications, the tungsten layer may be deposited over one or more barrier layers, for example, including titanium and/or titanium nitride (TiN). The dielectric layer may be a metal oxide such as a silicon oxide layer derived from tetraethylorthosilicate (TEOS), porous metal oxide, porous or non-porous carbon doped silicon oxide, fluorine-doped silicon oxide, glass, organic polymer, fluorinated organic polymer, or any other suitable high or low-k insulating layer.

The polishing method of the invention is particularly suited for use in conjunction with a chemical mechanical polishing (CMP) apparatus. Typically, the apparatus includes a platen, which, when in use, is in motion and has a velocity that results from orbital, linear, or circular motion, a polishing pad in contact with the platen and moving with the platen when in motion, and a carrier that holds a substrate to be polished by contacting and moving relative to the surface of the polishing pad. The polishing of the substrate takes place by the substrate being placed in contact with the polishing pad and the polishing composition of the invention and then the polishing pad moving relative to the substrate, so as to abrade at least a portion of the substrate (such as tungsten, titanium, titanium nitride, and/or a dielectric material as described herein) to polish the substrate.

The disclosed embodiments may be particularly well suited for tungsten buff and bulk tungsten CMP operations. As known to those of ordinary skill in the art, tungsten CMP operations commonly include a bulk process that is intended to remove at least a portion the tungsten overlayer (e.g., most or all of the overlayer) and a buff process intended to remove at least a portion of one of the barrier layer(s) (e.g., titanium or titanium nitride) and eliminate defects imparted by the bulk process. The buff process is also commonly intended to improve both local and global planarity. In certain advantageous embodiments, the disclosed polishing composition may provide for high planarization efficiency (particularly improved erosion) to be achieved for a substrate having a tungsten or molybdenum metal layer and a dielectric layer.

A substrate may be planarized or polished with the chemical mechanical polishing composition with any suitable polishing pad (e.g., polishing surface). Suitable polishing pads include, for example, woven and non-woven polishing pads. Moreover, suitable polishing pads can comprise any suitable polymer of varying density, hardness, thickness, compressibility, ability to rebound upon compression, and compression modulus. Suitable polymers include, for example, polyvinylchloride, polyvinylfluoride, nylon, fluorocarbon, polycarbonate, polyester, polyacrylate, polyether, polyethylene, polyamide, polyurethane, polystyrene, polypropylene, coformed products thereof, and mixtures thereof.

It will be understood that the disclosure includes numerous embodiments. These embodiments include, but are not limited to embodiments listed in the accompanying claims.

### Example 1

Four colloidal silica containing compositions were prepared and evaluated. The colloidal silica particles were modified with bis(trimethoxysilylpropyl)amine (a dipodal aminosilane) via heat treatment. The theoretical modification levels were 10 percent (1A), 4 percent (1B), 5 percent (1C), and 25 percent (1D). The colloidal silica particles in compositions 1A, 1B, and 1C were not highly modified and the colloidal silica particles in composition 1D were highly modified. Each composition included about 12 weight percent of the colloidal silica particles and was passed through a mixed bed ion exchange column after modification. The final pH of each composition was about 4.

The particle size, aspect ratio (AR50), and aggregation of each of the colloidal silicas are listed in Table 1A. The particle size distribution of each of the colloidal silica compositions was measured using a CPS Disc Centrifuge Particle size analyzer (e.g., Model DC24000 HR) available from CPS Instruments, Prairieville, Louisiana. Standard instrument settings were used to obtain the distributions (the CPS D50 is listed in Table 1A). The AR50 and aggregation parameters were obtained from TEM images.

Samples of each of the colloidal silica compositions were prepared for TEM imaging by drop-casting 30 μL samples onto lacey carbon-coated Cu grids deployed on filters to wick away excess liquid. After drying, multiple TEM bright field images were obtained of the remaining particles (the particles that remain after wicking away of the liquid). In this example, 20 images were obtained for each sample and were stacked into a single file using FIJI open source image processing software (https://en.wikipedia.org/wiki/Fiji_(software). Each image was obtained at a magnification of 20,000 and included 2048×2048 pixels. Using the FIJI software, the background was subtracted (using a rolling ball process) and the images were contrast enhanced to scale the intensity resolution. The pixel size was computed and input into the software (using the image scale bar). Machine learning software (using the trainable WEKA segmentation algorithm available in FIJI) was used to create binary images of the particle and background (a black particle in a white background). The machine learning software was user guided with the user defining selected particles. The WEKA software then evaluated selected images in the stack. An iterative process enabled the software to accurately find the particles. The learned algorithm was then applied to whole stack to generate binary images. A particle analyzing routine (available in FIJI) was then applied to the images in the stack to compute an aspect ratio for each identified particle in each image (the aspect ratio being defined as the maximum caliper diameter of the particle divided by the minimum caliper diameter of the particle). The median value (AR50) was computed and is recorded in Table 1A for each of the colloidal silica compositions.

The TEM images were further analyzed to evaluate a degree of aggregation for each of the compositions. The degree of aggregation was evaluated by counting the number percentage of colloidal silica particles having three or more primary particles (trimer+) and the number percentage of primary particles having either one or two primary particles (dimer−). The results are also recorded in Table 1A.

TABLE 1A

| Colloidal | | Percent | Percent | Particle |
|---|---|---|---|---|
| Silica | AR50 | Trimer(+) | Dimer(−) | Size (nm) |
| 1A | 1.08 | 0.8 | 99.2 | 111 |
| 1B | 1.08 | 0.8 | 99.2 | 111 |
| 1C | 1.45 | 39 | 61 | 47 |
| 1D | 1.45 | 39 | 61 | 47 |

Each of compositions 1A, 1B, 1C, and 1D was diluted in deionized water to a colloidal silica concentration of 1 weight percent. The IEP values were determined by titrating the samples using the electroacoustic method via a Colloidal Dynamics Zetaprobe. The diluted samples were titrated with 0.1N potassium hydroxide for a base titration up to a sample pH of 10.5. The zeta potentials were measured at increments of 0.5 pH units during the titration. The IEP was identified by determining the pH value at which the zeta potential was 0 mV via interpolation between the pH values at which the zeta potential transitioned from positive to negative. The IEP results are shown in Table 1B along with the corresponding percent theoretical surface coverage of each composition.

TABLE 1B

| Colloidal | Aminosilane | |
|---|---|---|
| Silica | Level | IEP |
| 1A | 10% | 7.3 |
| 1B | 4% | 6.6 |
| 1C | 5% | 6.5 |
| 1D | 25% | 8.6 |

As is apparent from the results set forth in Table 1B, each of the modified colloidal silicas had an IEP of greater than 6 with the highly modified colloidal silica 1D having an IEP of greater than 8 (8.6) and the modified colloidal silica particles having an IEP of less than 7.5.

### Example 2

Three colloidal silica containing compositions were prepared and evaluated. The first composition (2A) was identical to composition 1D in Example 1. The second composition (2B) included colloidal silica particles identical to the premodified colloidal silica particles in compositions 1C and 1D that were modified with aminopropyltrimethoxysilane (a monopodal aminosilane) via heat treatment at a theoretical modification level of 25 percent. The pH was adjusted to about 4 and the composition was passed through a mixed bed ion exchange column. Composition 2B included about 16 weight percent of the colloidal silica particles. The third composition (2C) was prepared by passing composition 2B through the mixed bed ion exchange column a second time. Some water was added during the second ion exchange process to prevent gelling such that composition 2C included about twelve weight percent of the colloidal silica particles.

The total aminosilane concentration in each of the compositions was determined by digesting the composition (including the modified colloidal silica particles) in concentrated potassium hydroxide and evaluating the digested composition using proton nuclear magnetic resonance (NMR). The free amino silane concentration of each composition was measured by first removing the modified colloidal silica particles from the compositions by ultra-centrifugation (40,000 rpm for 1 h) and then testing the decanted liquid layer using LCMS (for composition 2A in which the aminosilane concentration was less than 100 ppm) and NMR (for compositions 2B and 2C for which the aminosilane concentrations were greater than 100 ppm). The amount of free aminosilane per 1% of the modified colloidal silica was calculating by dividing the amount of free aminosilane by the percent solids (silica) of the composition. The amount of bound (modifying) aminosilane was calculated as the difference between the measured total aminosilane and the measured unbound aminosilane. The modification level was calculated by dividing the amount of bound (modifying) aminosilane by the total amount of aminosilane used to modify the colloidal silica particles in compositions 2A and 2B and multiplying the quotient by 25% (the theoretical modification level). The measured and computed quantities are reported in Table 2.

TABLE 2

| | | Free | Total | Bound | Free | |
|---|---|---|---|---|---|---|
| Compo- | % | AS | AS | AS | AS 1% | Modification |
| sition | Silica | (ppm) | (ppm) | (ppm) | CS (ppm) | Level (%) |
| 2A | 12.4 | 60 | 4398 | 4338 | 5 | 24.5 |
| 2B | 16.2 | 807 | 4411 | 3604 | 50 | 18.8 |
| 2C | 11.8 | 598 | 3417 | 2819 | 51 | 14.7 |

As is apparent in Table 2, composition 2A including the dipodal amino silane compound had an actual modification level nearly equal to the theoretical modification level (about 25 percent) and a low concentration of the modifying aminosilane compound free in the liquid carrier (about 5 ppm per 1 weight percent silica). Compositions 2B and 2C including the monopodal amino silane compound had actual modification levels that were significantly less than the theoretical modification level (about 19 percent and about 15 percent) and a significant quantity of the modifying aminosilane compound free in the liquid carrier (about 50 ppm per 1 weight percent silica). It is apparent in this example that the modification level of the monopodal aminosilane compound was not stable on the colloidal silica particles at high modification levels (levels above about 20 percent) and was leaving the surface of the silica particles into the liquid carrier.

### Example 3

Blanket wafer polishing performance was evaluated for ten polishing compositions. Patterned wafer polishing performance was evaluated for five of the ten polishing compositions. Each polishing composition included 1.5 weight percent modified colloidal silica prepared using colloidal silicas 1A, 1C, and 1D described above in Example 1. Further details regarding these compositions are shown in Table 3A in which all amounts are listed as either weight percent (%) or parts per million by weight (ppm).

TABLE 3A

| | | | Malonic | | | |
|---|---|---|---|---|---|---|
| Compo- | Colloidal | Fe(NO₃)₃•9H₂O | Acid | H₂O₂ | Diquat | |
| sition | Silica | (ppm) | (ppm) | (%) | (ppm) | pH |
| 3A | 1.5% 1C | 0 | 0 | 0.5 | 29 | 4.7 |
| 3B | 1.5% 1C | 60 | 120 | 0.5 | 29 | 4.4 |
| 3C | 0.75% 1A | 0 | 0 | 0.5 | 22 | 4.2 |
| | 0.75% 1C | | | | | |
| 3D | 0.75% 1A | 36 | 72 | 0.5 | 22 | 4.7 |
| | 0.75% 1C | | | | | |
| 3E | 0.75% 1A | 36 | 72 | 0.5 | 22 | 4.2 |
| | 0.75% 1C | | | | | |
| 3F | 0.75% 1A | 36 | 72 | 0.5 | 29 | 4.2 |
| | 0.75% 1C | | | | | |
| 3G | 1.5% 1D | 0 | 0 | 0.5 | 29 | 4.7 |
| 3H | 1.5% 1D | 36 | 72 | 0.5 | 22 | 4.7 |
| 3I | 1.5% 1D | 36 | 72 | 0.5 | 22 | 4.7 |
| 3J | 0.75% 1A | 36 | 72 | 0.5 | 22 | 4.7 |
| | 0.75% 1D | | | | | |

In Table 3A, Diquat represents a diquaternary amine. In this example, compositions 3A, 3B, 3G, and 3H included either 22 or 29 ppm N,N,N′,N′,N′-pentamethyl-N-tallow-1,3-propane-diammonium dichloride and compositions 3C, 3D, 3E, 3F, 3I, and 3J included either 22 or 29 ppm Starquat® DCE 1214 (a diquaternary ammonium salt of dimethylcocoamine bis(chloroethyl)ether).

Tungsten, TEOS, and PE-SiN polishing rates were obtained by polishing 300 mm blanket tungsten, TEOS, and PE-SiN wafers. The wafers were polished using a Reflexion® CMP polishing tool (Applied Materials) and a VP6000 polishing pad (DuPont) at a downforce of 1 psi, a platen speed of 54 rpm, a head speed of 49 rpm, and a slurry flow rate was 250 mL/min. Blanket wafer polishing rates are shown in table 3B.

Patterned wafer polishing performance (patterned oxide removal rate, array erosion, and line dishing values) were obtained by polishing 300 mm 2kÅ Silyb 754 tungsten patterned wafers (available from Silyb Wafer Services). Each patterned wafer was first polished to optical end-point (with no over-polish) using a Reflexion® CMP polishing tool (Applied Materials), an IC-1010 polishing pad (DuPont), and W8051 tungsten CMP polishing slurry (available from Entegris) at a downforce of 2 psi, a platen speed of 100 rpm, a head speed of 101 rpm, and a slurry flow rate was 250 mL/min. These prepped wafers were then buff polished (buffed) using a Reflexion® CMP polishing tool (Applied Materials), a VP6000 polishing pad (DuPont), and the disclosed compositions at a downforce of 1 psi, a platen speed of 54 rpm, a head speed of 49 rpm, and a slurry flow rate was 250 mL/min. Each patterned wafer was buffed for 60 seconds (with the exception of composition 3A for which the patterned wafer was buffed for 40 seconds). The array erosion and line recessing values were obtained using atomic force microscope (AFM) profilometer measurements across a 1×1 micron line features. The patterned wafer polishing data is shown in Table 2C.

TABLE 3B

| | Colloidal | W RR | TEOS RR | PE-SIN RR |
|---|---|---|---|---|
| Composition | Silica | (Å/min) | (Å/min) | (Å/min) |
| 3A | 1.5% 1C | 70 | 636 | 18 |
| 3B | 1.5% 1C | 413 | 604 | 63 |
| 3C | 0.75% 1A | 81 | 414 | 15 |
| | 0.75% 1C | | | |
| 3D | 0.75% 1A | 395 | 349 | 47 |
| | 0.75% 1C | | | |
| 3E | 0.75% 1A | 364 | 400 | 38 |
| | 0.75% 1C | | | |
| 3F | 0.75% 1A | 247 | 412 | 40 |
| | 0.75% 1C | | | |
| 3G | 1.5% 1D | 11 | 21 | 14 |
| 3H | 1.5% 1D | 251 | 30 | 13 |
| 31 | 1.5% 1D | 316 | 31 | 14 |
| 3J | 0.75% 1A | 288 | 158 | 18 |
| | 0.75% 1D | | | |

TABLE 3C

| | Colloidal | Pattern Oxide | Dishing | Erosion |
|---|---|---|---|---|
| Composition | Silica | RR (Å/min) | (Å) | (Å) |
| 3A | 1.5% 1C | 666 | −217 | 24 |
| 3C | 0.75% 1A | 336 | −225 | 156 |
| | 0.75% 1C | | | |
| 3E | 0.75% 1A | 272 | −87 | 221 |
| | 0.75% 1C | | | |
| 3F | 0.75% 1A | 277 | −132 | 195 |
| | 0.75% 1C | | | |
| 3J | 0.75% 1A | 313 | −115 | 212 |
| | 0.75% 1D | | | |

As is apparent from the data set forth in Tables 3B and 3C, comparative composition 3A including colloidal silica 1C provided high TEOS removal rates and low PE-SiN rates. However, the tungsten removal rate was very low which results in unacceptably high negative dishing (protruding tungsten lines) (−217 Å). The addition of an iron catalyst (as in comparative composition 3B) significantly increased the tungsten removal rate (from 70 Å/min to 413 Å/min), but also increased the PE-SiN removal rate to an unacceptably high value (from 18 Å/min to 63 Å/min). Comparative compositions 3C, 3D, 3E, and 3F included a 50/50 blend of colloidal silicas 1A and 1C as indicated. Comparative composition 3C exhibited a high TEOS removal rate (414 Å/min) and a very low PE-SiN removal rate (15 Å/min), however also exhibited an unacceptably low tungsten removal rate (81 Å/min). The resulting patterned wafer data had unacceptably high negative dishing (−225 Å). Comparative compositions 3D, 3E, and 3F further included an iron catalyst. While the tungsten removal rates were significantly improved (395 Å/min, 364 Å/min, and 247 Å/min) and the dishing values were acceptable (−87 Å and −132 Å for compositions 3E and 3F), the PE-SiN removal rates were unacceptably high (47 Å/min, 38 Å/min, and 40 Å/min) for each of these comparative compositions.

Compositions 3G, 3H, and 3I included the highly modified colloidal silica 1D. While each of these compositions included a desirably low PE-SiN removal rate (14 Å/min, 13 Å/min, and 14 Å/min), the TEOS removal rates were unacceptably low for a buff composition (21 Å/min, 30 Å/min, 31 Å/min). No patterned wafers were polished owing to the low TEOS removal rates. Composition 3J included a 50/50 blend of colloidal silicas 1A and 1D as indicated. The inventive composition 3J achieved acceptably high tungsten and TEOS removal rates (288 Å/min and 158 Å/min) as well as a desirably low PE-SiN removal rate (18 Å/min) and a desirably low negative dishing (−115 Å). It is readily apparent that this desirable combination of polishing performance attributes (acceptably high tungsten and TEOS removal rates, low PE-SiN removal rate, and low negative dishing) was only achieved using the mixture of highly modified colloidal silica particles and modified colloidal silica particles.

### Example 4

Blanket wafer polishing performance was evaluated for ten polishing compositions. Each polishing composition included 1.0 weight percent colloidal silica prepared by blending colloidal silicas 1A and 1D described above in Example 1. The amounts of colloidal silicas 1B and 1D are shown in Table 4. Each polishing composition further included 54 ppm by weight Fe(NO₃)₃·9H₂O, 109 ppm by weight malonic acid, 0.06 weight percent (600 ppm by weight) hydrogen peroxide, and had a pH of 4.7. The polishing compositions further included 11, 22, 33, or 44 ppm by weight N,N,N′,N′,N′-pentamethyl-N-tallow-1,3-propane-diammonium dichloride (DiQuat) as also shown in Table 4.

The zeta potential of the colloidal silica particles in each of the polishing compositions was measured using a Zetasizer® available from Malvern Instruments at 1 weight percent total colloidal silica and at a pH of about 4.7. These zeta-potential values are also recorded in Table 4.

Tungsten, TEOS, and PE-SiN polishing rates were obtained by polishing 300 mm blanket tungsten, TEOS, and PE-SiN wafers on a Reflexion® CMP polishing tool (Applied Materials) and a VP6000 polishing pad (DuPont). The wafers were polished using a platen speed of 54 rpm, a head speed of 49 rpm, a downforce of 1 psi, and slurry flow rate was 250 mL/min. Polishing results are shown in Table 4.

TABLE 4

| | | | Zeta | W | TEOS | PE-SiN |
|---|---|---|---|---|---|---|
| Compo- | Colloidal | Diquat | Potential | RR | RR | RR |
| sition | Silica | (ppm) | (mV) | (Å/min) | (Å/min) | (Å/min) |
| 4A | 0.5% 1A | 11 | 31 | 130 | 370 | 18 |
| | 0.5% 1D | | | | | |
| 4B | 0.33% 1A | 22 | 29 | 95 | 310 | 19 |
| | 0.66% 1D | | | | | |
| 4C | 0.50% 1A | 22 | 28 | 104 | 365 | 17 |
| | 0.50% 1D | | | | | |
| 4D | 0.66% 1A | 22 | 32 | 82 | 365 | 16 |
| | 0.33% 1D | | | | | |
| 4E | 0.17% 1A | 33 | 37 | 52 | 360 | 17 |
| | 0.83% 1D | | | | | |
| 4F | 0.33% 1A | 33 | 35 | 60 | 372 | 18 |
| | 0.66% 1D | | | | | |
| 4G | 0.50% 1A | 33 | 32 | 60 | 367 | 15 |
| | 0.50% 1D | | | | | |
| 4H | 0.58% 1A | 33 | 40 | 78 | 366 | 20 |
| | 0.42% 1D | | | | | |
| 4I | 0.66% 1A | 33 | 30 | 101 | 308 | 19 |
| | 0.33% 1D | | | | | |
| 4J | 0.58% 1A | 44 | 32 | 60 | 365 | 19 |
| | 0.42% 1D | | | | | |

As is apparent from the results set forth in Table 4, high TEOS removal rates, and very low PE-SiN removal rates were achieved for each of the polishing compositions (over a range of ratios of colloidal silicas 1A and 1D). The tungsten removal rates were also observed to be acceptably high for each of the compositions (for compositions including the very low hydrogen peroxide concentration of 0.06 weight percent). Moreover, it will be appreciated that compositions including a ratio from about 2:1 to about 1:2 of colloidal silica 1A to colloidal silica 1D achieved the highest tungsten removal rates (depending on the diquaternary amine concentration).

### Example 5

Five polishing compositions were prepared. Each composition included 890 ppm by weight malonic acid, 412 ppm by weight ferric nitrate nonahydrate, 5 ppm by weight benzotriazole, 20 ppm by weight epsilon poly-L-lysine (hydrochloride), 17 ppm by weight Proxel Ultra 10 preservative, 0.3 weight percent colloidal silica (0.2475 weight percent of a first colloidal and 0.0525 weight percent of a second colloidal silica), and 5 weight percent hydrogen peroxide. The pH was 2.6. The first colloidal silica included colloidal silica 1A from Example 1. The second colloidal silica was structurally identical to colloidal silica 1D, but had varying modification levels of bis(trimethoxysilylpropyl)amine. The modification levels are reported in Table 5A.

Blanket and patterned wafer polishing performance was obtained by polishing 200 mm blanket and patterned wafers using a Mirra® CMP polishing tool (Applied Materials) and an E6088 (Entegris) polishing pad with in-situ conditioning using a Saesol 8031C1 disk at 6 lbs. The wafers were polished at a downforce of 2.5 psi, a platen speed of 100 rpm, a head speed of 85 rpm, and a slurry flow rate of 150 mL/min. The patterned wafers (2kÅ Silyb 854 tungsten, available from Silyb Wafer Services) were polished to optical end-point with a 30 percent over-polish. The blanket wafer performance is shown in Table 5A and the patterned wafer performance is shown in Table 5B.

TABLE 5A

| Polishing | Modification | Tungsten RR | TEOS RR | W/TEOS |
|---|---|---|---|---|
| Composition | Level (%) | (Å/min) | (Å/min) | Selectivity |
| 5A | 5 | 2143 | 23 | 105 |
| 5B | 10 | 2400 | 22 | 109 |
| 5C | 15 | 2532 | 23 | 110 |
| 5D | 25 | 2361 | 19 | 124 |
| 5E | 40 | 2383 | 22 | 108 |

TABLE 4B

| | Dishing | Erosion | Erosion | Oxide Loss |
|---|---|---|---|---|
| Polishing | 1 × 1 μm | 1 × 1 μm | 180 × 180 nm | 1 × 1 μm |
| Composition | (Å) | (Å) | (Å) | (Å) |
| 5A | 215 | 173 | 176 | 129 |
| 5B | 221 | 177 | 171 | 127 |
| 5C | 220 | 184 | 153 | 134 |
| 5D | 163 | 69 | 68 | 108 |
| 5E | 195 | 75 | 51 | 124 |

As is readily apparent from the data set forth in Tables 5A and 5B, polishing compositions 5D and 5E including the highly modified colloidal silica particles exhibit significantly improved erosion and dishing and have similar oxide loss and tungsten removal rates as compared to the compositions not including the highly modified colloidal silica particles (5A-5C).

### Example 6

Four polishing compositions were prepared. Each composition included 890 ppm by weight malonic acid, 412 ppm by weight ferric nitrate nonahydrate, 5 ppm by weight benzotriazole, 17 ppm by weight Proxel Ultra 10 preservative, 0.3 weight percent colloidal silica (0.2 weight percent of colloidal silica 1B and 0.1 weight percent of either colloidal silica 1C or 1D), and 5 weight percent hydrogen peroxide. The pH was 2.7. Polishing compositions 6C and 6D further included 22 ppm by weight epsilon poly-L-lysine (hydrochloride). Polishing compositions 6B and 6D included the highly modified colloidal silica 1D while compositions 6A and 6C included the modified colloidal silica 1C. The zeta potential of each composition was measured using a Zetasizer® (Malvern) and is reported in Table 4A.

Blanket and patterned wafer polishing performance was obtained by polishing 300 mm blanket and patterned wafers using a Reflexion® CMP polishing tool (Applied Materials) and an E6088 (Entegris) polishing pad with 18 seconds of ex-situ conditioning using a 3M A122 disk at 7 lbs. The wafers were polished at a downforce of 3.5 psi, a platen speed of 80 rpm, a head speed of 81 rpm, and a slurry flow rate was 100 mL/min. The patterned wafers (2kÅ Silyb 754 tungsten, available from Silyb Wafer Services) were polished to optical end-point with an additional fixed 20 seconds of over-polish time. The blanket wafer performance is shown in Table 6A and the patterned wafer performance is shown in Table 6B.

TABLE 6A

| Polishing | Colloidal | Zeta Potential | Tungsten RR | TEOS RR |
|---|---|---|---|---|
| Composition | Silica | (mV) | (Å/min) | (Å/min) |
| 6A | 1B + 1C | 34 | 3613 | 103 |
| 6B | 1B + 1D | 35 | 3838 | 78 |
| 6C | 1B + 1C | 32 | 3658 | 86 |
| 6D | 1B + 1D | 34 | 3638 | 69 |

TABLE 6B

| | | Erosion | Erosion | Erosion |
|---|---|---|---|---|
| Polishing | Pattern W | 1 × 1 μm | 3 × 1 μm | 180 × 180 nm |
| Composition | RR (Å/min) | (Å) | (Å) | (Å) |
| 6A | 3556 | 418 | 867 | 455 |
| 6B | 3896 | 625 | 1105 | 563 |
| 6C | 3793 | 549 | 856 | 571 |
| 6D | 4002 | 384 | 600 | 414 |

As is readily apparent from the data set forth in Tables 6A and 6B, polishing composition 6D including the highly modified colloidal silica particles and the cationic polymer (EPLL) exhibits improved erosion and a moderately improved patterned tungsten removal rate as compared to the compositions not including the highly modified colloidal silica particle (6A and 6C). Moreover, composition 6B including the highly modified colloidal silica particles but no cationic polymer exhibited the highest erosion, thereby indicating the positive interaction between the highly modified colloidal silica particles and the cationic polymer.

### Example 7

Eight polishing compositions were prepared. Each composition included 890 ppm by weight malonic acid, 412 ppm by weight ferric nitrate nonahydrate, 5 ppm by weight benzotriazole, 17 ppm by weight Proxel Ultra 10 preservative, colloidal silica particles (combinations of colloidal silicas 1B and 1C or 1D as indicated in table 7A), and 5 weight percent hydrogen peroxide. The pH was 2.6. Polishing compositions 7A, 7B, 7E, and 7F further included 22 ppm by weight epsilon poly-L-lysine (hydrochloride) as also indicated in Table 7A.

Patterned wafer polishing performance was obtained by polishing 300 mm patterned wafers (2kÅ Silyb 754 tungsten, available from Silyb Wafer Services) using a Reflexion® CMP polishing tool (Applied Materials) and an E6088 (Entegris) polishing pad with 18 seconds of ex-situ conditioning using a 3M A122 disk at 7 lbs. The wafers were polished to optical end-point with an additional 20 fixed seconds over-polish time at a downforce of 3.5 psi, a platen speed of 80 rpm, a head speed of 81 rpm, and a slurry flow rate was 100 mL/min. Polishing composition details are shown in Table 7A and the patterned wafer performance is shown in Table 7B.

TABLE 7A

| Polishing | Colloidal Silica | Colloidal Silica | Cationic |
|---|---|---|---|
| Composition | 1B (wt. %) | 1C or 1D (wt. %) | Polymer (ppm) |
| 7A | 0.2 | 0.1 1C | 22 |
| 7B | 0.2 | 0.1 1D | 22 |
| 7C | 0.2 | 0.1 1C | 0 |
| 7D | 0.2 | 0.1 1D | 0 |
| 7E | 0.066 | 0.233 1C | 22 |
| 7F | 0.066 | 0.233 1D | 22 |
| 7G | 0.066 | 0.233 1C | 0 |
| 7H | 0.066 | 0.233 1D | 0 |

TABLE 7B

| | | Erosion | Erosion |
|---|---|---|---|
| Polishing | Pattern W | 1 × 1 μm | 180 × 180 nm |
| Composition | RR (Å/min) | (Å) | (Å) |
| 7A | 3984 | 227 | 240 |
| 7B | 4291 | 119 | 145 |
| 7C | 3914 | 282 | 287 |
| 7D | 4276 | 419 | 387 |
| 7E | 4462 | 184 | 232 |
| 7F | 4524 | 96 | 107 |
| 7G | 3774 | 369 | 372 |
| 7H | 4216 | 641 | 582 |

As is evident from the data set forth in Tables 7A and 7B, polishing compositions 7B and 7F including the highly modified colloidal silica particles and the cationic polymer exhibit significantly improved erosion and moderately improved tungsten removal rates as compared to the other polishing compositions. Moreover, as in Example 5, compositions 7D and 7H including the highly modified colloidal silica particles but no cationic polymer exhibited the highest erosion, thereby indicating the positive interaction between the highly modified colloidal silica particles and the cationic polymer.

### Example 8

Three polishing compositions were prepared. Each composition included 890 ppm by weight malonic acid, 412 ppm by weight ferric nitrate nonahydrate, 5 ppm by weight benzotriazole, 17 ppm by weight Proxel Ultra 10 preservative, colloidal silica particles (combinations of colloidal silicas 1A or 1B and 1D as indicated in Table 8A), and 5 weight percent hydrogen peroxide. The pH was 2.7. Polishing composition 8A further included 8 ppm by weight epsilon poly-L-lysine (hydrochloride) (EPLL) and compositions 8B and 8C further included 10 and 20 ppm by weight Poly(diallyl dimethyl ammonium chloride) (pDADMAC).

Patterned wafer polishing performance was obtained by polishing 200 mm patterned wafers (2kÅ Silyb 754 tungsten, available from Silyb Wafer Services) using a Mirra® CMP polishing tool (Applied Materials) and an E6088 (Entegris) polishing pad with ex-situ conditioning using a Saesol 8031C1 disk at 6 lbs. The wafers were polished to optical end-point with an additional 30 percent of over-polish at a downforce of 2 psi, a platen speed of 115 rpm, a head speed of 121 rpm, and a slurry flow rate was 90 mL/min. Polishing composition details are shown in Table 8A and the patterned wafer performance is shown in Table 8B.

TABLE 8A

| Polishing | Colloidal Silica | Colloidal Silica | Cationic |
|---|---|---|---|
| Composition | 1A or 1B (wt. %) | 1D (wt. %) | Polymer (ppm) |
| 8A | 0.25 1B | 0.25 1D | 8 EPLL |
| 8B | 0.25 1A | 0.25 1D | 10 pDADMAC |
| 8C | 0.25 1A | 0.25 1D | 20 pDADMAC |

TABLE 8B

| | | Erosion | Erosion | Erosion |
|---|---|---|---|---|
| Polishing | Pattern W | 1 × 1 μm | 3 × 1 μm | 180 × 180 nm |
| Composition | RR (Å/min) | (Å) | (Å) | (Å) |
| 8A | 4505 | 406 | 777 | 544 |
| 8B | 4352 | 426 | 825 | 498 |
| 8C | 4115 | 269 | 496 | 368 |

As is evident from the data set forth in Tables 8A and 8B, polishing composition 8C including the highly modified colloidal silica particles and the pDADMAC cationic polymer exhibits good erosion performance and a high tungsten removal rate.

### Example 9

Two polishing compositions were prepared. Each composition included 0.267 weight percent malonic acid, 0.1236 weight percent ferric nitrate nonahydrate, 0.012 weight percent L-Histidine, 0.0024 weight percent epsilon poly-L-lysine (hydrochloride), 0.194 weight percent diallyldimethylammonium)chloride, 0.01 weight percent Proxel AQ preservative, and 1 weight percent colloidal silica particles. The pH was 2.1. Composition 9A included colloidal silica 1B. Composition 9B included the highly modified colloidal silica 1D. Each composition was prepared as a concentrate. Each composition was diluted with 11 parts of deionized water prior to polishing such that the amounts of each component in the compositions was one-twelfth of the amounts listed above. The diluted compositions each further included 3 weight percent hydrogen peroxide.

Blanket tungsten, molybdenum, and thermal oxide wafer coupons (4 cm square) were polished on a table top polisher using an optivision 4540 polishing pad (available form Pureon) with ex-situ conditioning at 6 lbs. The wafers were polished at a downforce of 2.5 psi, a platen speed of 115 rpm, a head speed of 121 rpm, and a slurry flow rate of 25 ml/min. The molybdenum wafer coupons were polished for 30 seconds, while the tungsten and thermal oxide wafer coupons were polished for 60 seconds. The polishing rates are shown in Table 9.

TABLE 9

| Polishing | Colloidal | Blanket Mo | Blanket W | Blanket Oxide |
|---|---|---|---|---|
| Composition | Silica | RR (Å/min) | RR (Å/min) | RR (Å/min) |
| 9A | 1B | 918 | 699 | 38 |
| 9B | 1D | 1155 | 893 | 32 |

As is evident from the results set forth in Table 9, the polishing composition including the highly modified colloidal silica exhibited higher molybdenum and tungsten removal rates as well as lower thermal oxide removal rates (and therefore both higher molybdenum to oxide selectivity and tungsten to oxide selectivity).

It will be understood that the recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A chemical mechanical polishing composition comprising:
a liquid carrier;
an iron-containing compound;
a cationic polymer or a cationic surfactant;
highly modified colloidal silica particles dispersed in the liquid carrier, the highly modified colloidal silica particles modified with an aminosilane compound such that the colloidal silica particles are positively charged in the polishing composition, wherein the highly modified colloidal silica particles have a modification level of the aminosilane compound of at least about 20 percent; and
a pH of less than about 4.5.

2. The composition of claim 1, wherein the modification level of the aminosilane compound is in a range from about 20 percent to about 50 percent.

3. The composition of claim 1, wherein the aminosilane compound is a multi-podal aminosilane compound.

4. The composition of claim 1, wherein the highly modified colloidal silica particles have an isoelectric point of greater than about 8.

5. The composition of claim 1, wherein the highly modified colloidal silica particles have a zeta potential in the polishing composition in a range from about 25 mV to about 50 mV.

6. The composition of claim 1, comprising from about 0.01 to about 1 weight percent of the highly modified colloidal silica particles at point of use.

7. The composition of claim 1, wherein the highly modified colloidal silica particles have an aspect ratio of greater than about 1.2.

8. The composition of claim 1, wherein the highly modified colloidal silica particles have a D50 particle size in a range from about 30 nm to about 60 nm.

9. The composition of claim 1, wherein the highly modified colloidal silica particles have a BET surface area in a range from about 60 m²/g to about 120 m²/g.

10. The composition of claim 1, further comprising hydrogen peroxide.

11. The composition of claim 1, wherein the cationic polymer or the cationic surfactant is a cationic polymer and the cationic polymer comprises polylysine, poly(diallyldimethylammonium), or a mixture thereof.

12. The composition of claim 1, wherein the cationic polymer or the cationic surfactant is a cationic surfactant and the cationic surfactant comprises a diquaternary amine cationic surfactant.

13. The composition of claim 1, further comprising other modified colloidal silica particles dispersed in the liquid carrier, the other modified colloidal silica particles modified with an aminosilane compound such that the other colloidal silica particles have a positive charge in the polishing composition, wherein the other modified colloidal silica particles have a modification level in a range from about 2 percent to about 15 percent.

14. A chemical mechanical polishing composition comprising:
a liquid carrier;
first colloidal silica particles dispersed in the liquid carrier, the first colloidal silica particles being modified with a first aminosilane compound such that the first colloidal silica particles are positively charged in the polishing composition, wherein the first colloidal silica particles have a modification level of the first aminosilane compound of at least about 20 percent;
second colloidal silica particles dispersed in the liquid carrier, the second colloidal silica particles being modified with a second aminosilane compound such that the second colloidal silica particles are positively charged in the polishing composition, wherein the second colloidal silica particles have a modification level of the second aminosilane compound in a range from about 1 percent to about 19 percent;
an iron-containing compound;
a cationic polymer or a cationic surfactant; and
a pH of less than about 4.5.

15. The composition of claim 14, wherein:
the first colloidal silica particles have a modification level of the first aminosilane compound in a range from about 20 percent to about 50 percent; and
the second colloidal silica particles have a modification level of the second aminosilane compound in a range from about 2 percent to about 15 percent.

16. A method of chemical mechanical polishing a tungsten or molybdenum containing substrate, the method comprising:
(a) contacting the substrate with a polishing composition comprising,
a liquid carrier;
an iron-containing compound;
a cationic polymer or a cationic surfactant;
highly modified colloidal silica particles dispersed in the liquid carrier, the highly modified colloidal silica particles modified with an aminosilane compound such that the colloidal silica particles are positively charged in the polishing composition, wherein the highly modified colloidal silica particles have a modification level of the aminosilane compound of at least about 20 percent; and
a pH of less than about 4.5;
(b) moving the polishing composition relative to the substrate; and
(c) abrading the substrate to remove tungsten or molybdenum from the substrate and thereby polish the substrate.

17. The method of claim 16, wherein the modification level of the aminosilane compound is in a range from about 20 percent to about 50 percent.

18. The method of claim 16, wherein the aminosilane compound is a multi-podal aminosilane compound.

19. The method of claim 16, wherein the highly modified colloidal silica particles have an isoelectric point of greater than about 8.

20. The method of claim 16, wherein the highly modified colloidal silica particles have a zeta potential in the polishing composition in a range from about 25 mV to about 50 mV.
